(19) United States
(12) Patent Application Publication
(10) Pub. No.: US 2003/0008804 A1
(43) Pub. Date: Jan. 9, 2003

(54) Starch graft copolymer, detergent builder composition including the same, and production method thereof

(76) Inventors: Qiu Xu, London (CA); Tzu Chun Lin, Taipei (TW); Fenbao Zhang, London (CA); Kuan Hsiu Hwu, Sao Paulo (BR)

Correspondence Address: BROWN, RAYSMAN, MILLSTEIN, FELDER & STEINER LLP, 900 THIRD AVENUE, NEW YORK, NY, 10022, US

(21) Appl. No.: 10/144,374

(22) Filed: May 13, 2002

(30) Foreign Application Priority Data
Jun. 5, 2001 (BR) PI0102267-9

(51) Int. Cl. C11D 3/37

(52) U.S. Cl. 510/475; 510/477

(57) ABSTRACT

A graft copolymer of acrylic acid and maleic acid (or anhydride) grafted onto starch, a detergent builder composition containing the graft copolymer and a method of preparing the graft copolymer. These novel starch graft copolymers are highly water-soluble and biodegradable, have strong chelation ability to calcium ions and magnesium ions, and strong pH buffering ability. The composition has no phosphate and aluminosilicate. The composition has excellent anti-redeposition, building, anti-filming, dispersing, threshold crystal-inhibiting and enzyme performance-improving properties.

### BACKGROUND OF THE INVENTION

1. Field of the Invention

The present invention relates to phosphate-free, aluminosilicate-free detergent compositions useful in detergent compositions, and more particularly relates to a novel class of starch graft copolymers and graft copolymers prepared by grafting acid-functional monomers onto natural polymer substrates (a regenerable resource such as mandioc, corn starch, etc.). The starch graft copolymers are especially effective and are relatively low in cost, highly water-soluble and biodegradable, preferably useful as a detergent-additive polymer acting as a builder, an alkaline pH buffer, a chelating agent of calcium and magnesium cations, an anti-filming agent, a dispersant, an anti-redeposition agent, an enzyme performance-improving agent, a sequestering agent and an encrustation inhibitor. The term detergent, as used herein, relates to textile laundering detergents, hard surface cleaners, such as formulations used in laundry machines and automatic dishwashers, and other compositions useful as cleaners.

2. Description of the Related Art

The term “detergent builder” can be applied to any component of a detergent composition which increases the detergent power of a surface active agent, hereinafter “surfactant”. Generally recognized functions of a detergent builder include removal of alkaline earth and other undesirable metal ions from washing solutions by sequestration or precipitation, provision of alkalinity and buffer capacity, prevention of flocculation, maintenance of ionic strength, protection of anionic surfactants from precipitation, and extraction of metals from stains as an aid to removal thereof. Polyphosphates such as tripolyphosphates and pyrophosphates are widely used as ingredients in detergent compositions and are highly effective detergent builders and relatively non-toxic. However, the effect of phosphorus on eutrophication of lakes and streams has caused concern, and legislation in many countries makes it necessary to substantially reduce the phosphate content in detergents or to supply non-phosphate detergents. These circumstances have brought about a need for highly effective and efficient phosphate-free detergent builders.

Many materials and combinations of materials have been used or proposed as detergent builders. Carbonates and silicates are widely used in granular detergent compositions, but by themselves are deficient as detergent builders in a number of respects. Aluminosilicates, such as described in U.S. Pat. No. 4,274,975 (issued Jun. 23, 1981 to Corkill et al.), have also been used to replace polyphosphates.

Aluminosilicates, however, have relatively low calcium- and magnesium-binding constants and can present solubility problems, particularly in combination with silicates. Another drawback is that the prices of aluminosilicates are not low.

Polycarboxylate polymers, especially acrylic and maleic polymers, are well-known ingredients of detergent compositions and provide various benefits. They are used, for example: as anti-redeposition and anti-encrustation agents; for detergency building, especially in conjunction with water-insoluble aluminosilicate builders; for the structuring of detergent powders; and for improving the free-flowing characteristics and solubility of granular detergents.

Published documents describing the use of acrylic and maleic polymers in detergent compositions include GB 1 460 893 (Unilever), which discloses polyacrylates; EP 25 551B (BASF), which discloses acrylic/maleic copolymers; and EP 124 913B (Procter & Gamble), which discloses detergent compositions containing combinations of polyacrylates and acrylic/maleic copolymers. U.S. Pat. No. 4,379,080 (Murphy, issued Apr. 5,1983) discloses the use of film-forming polymers in granular detergent compositions to improve the free-flowing characteristics and solubility of the granules. It is disclosed that the film-forming polymer may be a polyacrylate which has a molecular weight of from about 3,000 to about 100,000.

Although various polycarboxylate polymers have been disclosed in the literature as detergent ingredients, only polyacrylates and acrylate/maleate copolymers have found widespread use in commercial detergent products. These polymers, however, are not biodegradable and are expensive compared with tripolyphosphates.

During the past three decades, efforts have been made in the detergent industry to convert from the eutrophying polyphosphates to more environmentally acceptable materials such as polycarboxylic acid polymers (e.g., polyacrylic acids). In the same way, widely-used branched alkyl benzene sulfonates (ABS), which were probably the most popular surfactants, have been replaced by their biodegradable linear counterparts (LAS), so as to eliminate build-ups thereof in surface and subsurface waters.

While the polycarboxylic acid polymers and copolymers currently used in detergents and water treatment applications do not suffer from the same drawbacks as the phosphorus-containing inorganic builders or the foam-producing ABS surfactants, the past has taught that it is most desirable that chemicals used in large volume applications which enter the environment be biodegradable. Unfortunately, most polycarboxylic acid polymers and copolymers useful in detergent applications or as dispersants or as water treatment chemicals are not highly biodegradable.

Ether polycarboxylates, such as described in U.S. Pat. No.4,687,592 (issued Aug. 18, 1987 to Collins et al.), have been proposed as substitutes for polyphosphate detergent builders. These ether polycarboxylates need not contain phosphorus or nitrogen (which is also subject to environmental concerns when used in large amounts) and can be more rapidly biodegraded than polymeric polycarboxylates. But the biodegradation of ether polycarboxylates is still not high, and their prices are also high.

Many, but not necessarily all, ether polycarboxylates, are deficient in calcium-binding power relative to inorganic polyphosphates. This has been recognized, and modifications to detergent compositions have been suggested to overcome this and other deficiencies. The suggestions include an increase in surfactant levels and combination with inorganic alkaline materials such as sodium silicate and sodium carbonate.

It has now been found that starch graft polycarboxylate materials with a calcium-chelation ability or calcium-binding constant (expressed as log K_{Ca}) above a specified minimum value can be successfully incorporated in detergent compositions as part of a builder composition. The resultant detergent compositions provide, in a non-phosphate composition, fabric cleaning in a household laundry context essentially equivalent to that provided by compositions containing from about 25% to about 50% by weight of an alkali metal polyphosphate such as sodium tripolyphosphate. Other builders referred to herein are iron- and manganese-chelating agents and polymeric polycarboxylate dispersing agents.

U.S. Pat. No.5,591,703 (Sadlowski, issued Jan. 7, 1997) discloses that low molecular weight modified polyacrylate copolymers can enhance anti-filming performance in automatic dishwashing detergent compositions. In addition, not only do the low molecular weight modified polyacrylates of that invention prevent hard water filming due to precipitation but, surprisingly, it has been found that these modified polyacrylate copolymers show improved enzyme performance (i.e., bulk food removal) in enzyme-containing automatic dishwashing detergent compositions.

### SUMMARY OF THE INVENTION

It is an object of the present invention to provide a method to prepare a novel class of highly water-soluble and biodegradable copolymers of acid-functional monomers grafted onto natural polymers. It is a further object of this invention to provide a novel class of highly water-soluble and biodegradable graft copolymers. It is a still further object of this invention to provide a non-phosphate, non-aluminosilicate detergent builder composition useful in detergent compositions.

The detergent builder composition may include from about 1% to about 30% by weight of an alkali metal silicate having a molar ratio of from about 1.6 to about 2.4.

Disclosed in the present invention are water-soluble graft polymers prepared by graft copolymerization of monomer mixtures of one or more monoethylenically unsaturated monocarboxylic acids, one or more co-monomers having at least two unsaturated non-conjugate double bonds and at least one COO—X group, and other water-soluble unsaturated monomers. Studies of these copolymers have revealed that they are easy to make and provide a balance of good performance properties, biodegradability and low cost.

It has now been discovered that graft copolymers prepared by grafting acid-functional monomers onto completely biodegradable substrates (including regenerable resources such as mandioc, corn starch, etc.) form starch graft copolymers which are highly water-soluble and biodegradable, and are useful as detergent additives.

### BRIEF DESCRIPTION OF THE DRAWINGS

FIG. 1 is a magnified micrograph showing an example of a starch.

FIG. 2 is a magnified micrograph showing an example of a starch graft copolymer of the present invention.

FIG. 3 is a magnified micrograph showing another example of a starch graft copolymer of the present invention.

### DETAILED DESCRIPTION OF THE INVENTION

The present invention relates to a phosphate-free, aluminosilicate-free detergent builder composition which contains modified starch graft copolymers which have excellent water-solubility and high biodegradability and can be used as anti-soiling and anti-redeposition agents for the aqueous washing of textile articles. The novel class of starch graft copolymers have strong chelation ability to calcium ions and magnesium ions and strong buffer function, and have building, anti-filming, dispersing, and threshold crystal-inhibiting properties and enzyme performance-improving abilities.

It is known that detergent compositions currently marketed for the washing of synthetic or natural textile articles are complex mixtures of different products, all of which have well specified functions, such as metal-complexing agents, surfactants, anti-corrosion agents, detergents, anti-redeposition agents, bleaching agents and anti-soiling agents.

Metal-complexing agents have the ability to remove metal ions other than alkali metal ions from washing solutions by sequestration, which as defined herein includes chelation, or by precipitation reactions.

Anti-redeposition agents essentially avoid deposition of soiling on the textile fibers and especially avoid redeposition of soils removed during washing.

Anti-soiling agents essentially reduce the affinity of textile fibers for soils, especially for greasy soils, and thereby facilitate removal thereof.

The present invention provides new modified starch graft copolymers having strong chelation ability to calcium ions and magnesium ions, a strong buffer function, and anti-redeposition and soiling-removal properties, and having building, anti-filming, dispersing, threshold crystal-inhibiting properties and enzyme performance-improving abilities, and which are especially effective and relatively low in cost.

According to another aspect, the present invention provides a detergent builder composition substantially free of phosphate and aluminosilicate employing these new modified starch graft copolymers.

These new modified starch graft copolymers of the general type described herein are a novel class of highly biodegradable water-soluble graft copolymers. Their preparation is considered to be well within the capability of the person of ordinary skill in the art.

The copolymers of this invention are prepared by grafting acid-functional monomers onto natural product substrates by way of an aqueous polymerization process utilizing water-soluble, free radical-forming initiators and a metal salt. These graft copolymers are biodegradable and are useful as detergent additives and builders, dispersants, alkaline pH buffers, chelates of calcium and magnesium cations, anti-filming agents, anti-redeposition agents, enzyme performance-improving agents, sequestering agents and encrustation inhibitors.

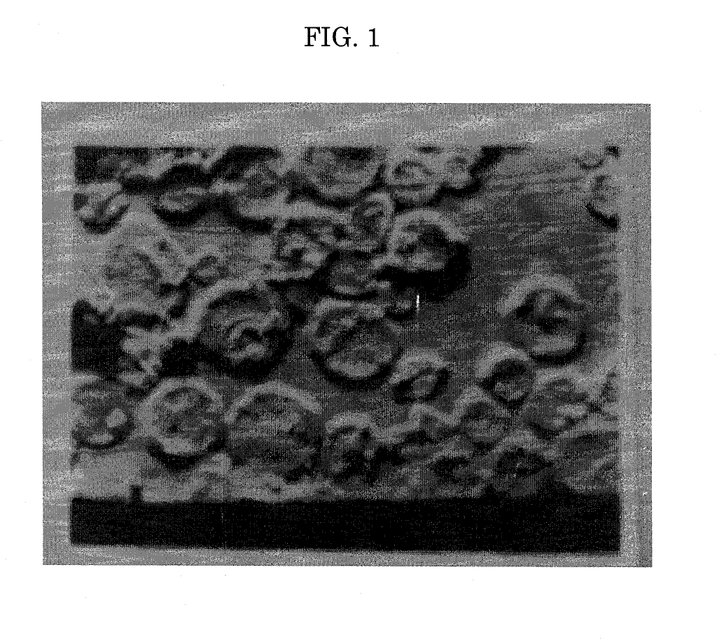

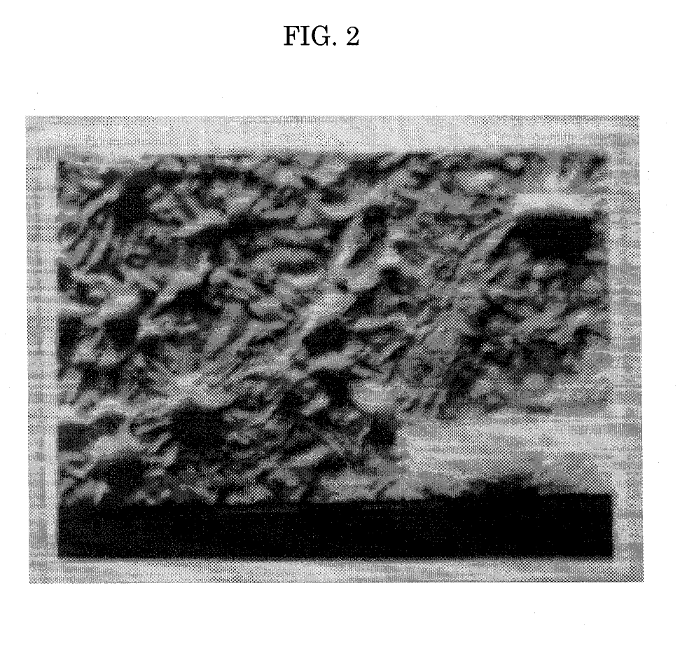

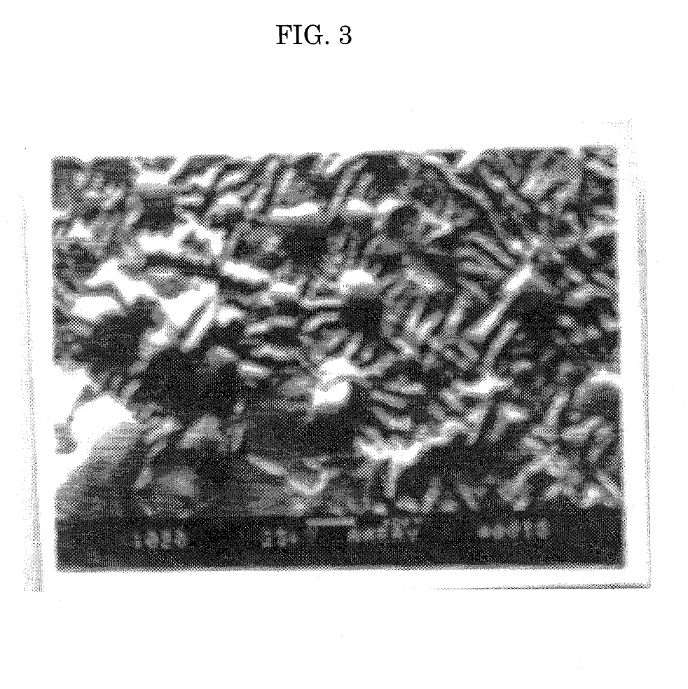

Although the mechanism of the process set forth herein is not fully understood, it is believed that the metal salts used in the grafting reaction of the present invention act as polymerization moderators, that is, they control the molecular weight, chain length and degree of branching of the grafted side chains. Starch itself is a completely biodegradable natural polymer. The structure of starch is a kind of bare core. When maleic acid/anhydride and acrylic acid graft onto starch, the starch core is attached with lots of short linear branches. Because starch is completely biodegradable, it is believed that the starch graft copolymers are also highly biodegradable. It is thought that when the starch in the copolymer is biodegraded, the structure of the copolymer is broken, becoming lot of small pieces, which are short linear copolymers. Pictures of starch and starch graft copolymer were obtained using an electron microscope KYKy-1000B (see attached FIGS. 1, 2 and 3). This theory of the invention is presented here as a possible explanation for the surprising results obtained, and is in no way intended to limit the scope of this invention.

The starting substrates onto which the acid-functional monomers can be grafted are completely biodegradable and include natural materials such as mandioc, corn starch, wheat starch, etc. A more preferable substrate is corn starch. The weight ratio of the substrate to the total acid-functional monomers is preferably about 1:9 to 9:1, more preferably about 1:5 to 4:1, and even more preferably about 1:3 to 3:1.

Monomers useful in forming the graft side chains can contain as copolymerization units: acid-functional ethylenically unsaturated monomers such as acrylic acid, methacrylic acid, maleic acid, acrylamide related monomers and combinations thereof.

Initiators useful in this process include well-known water-soluble, free radical-forming compounds. Preferred water-soluble initiators which may be used include peroxidate, persulfate, perphosphate and azo initiators, including hydrogen peroxide, t-butyl hydroperoxide, sodium persulfate, potassium persulfate, ammonium persulfate, sodium perphosphate, ammonium perphosphate, potassium perphosphate, and combinations thereof. More preferred initiators include hydrogen peroxide and persulfate. The initiator concentration is normally between 0.1 and 50% by weight based on the total weight of the monomers, and more preferably from 0.2 to 20%. A weight ratio of persulfate to hydrogen peroxide is preferably from 40:1 to 1:1.

The present invention employs water-soluble metal salts, such as salts of iron, nickel, zinc, copper, cobalt and manganese, at very low levels, from about 0.1 to 100 parts per million (ppm) of the metal ions relative to the weight of the acid-functional copolymerizing monomers, and more preferably from about 1 to 80 ppm. The amount of metal ions present during the reaction is critical to the graft polymerization of the present invention. If the level of metal ions is too high, the monomer conversion rate will decrease to an unacceptably low level, and if the level of metal ions is too low, the effect of molecular weight control mentioned above will be diminished and the content of unreacted monomers will be undesirably high.

The graft copolymerization can be performed using batch processing and is performed preferably at a solids level of from 10% to 90%, more preferably from 30% to 60%. The copolymerization reaction is preferably performed at a temperature of from about 50 to 170 ° C. and more preferably from about 90 to 150° C.

The present invention discloses a method of preparation of the starch graft copolymer, which includes two steps. The first step is copolymerization of monoethylenically unsaturated monomers such as maleic acid/anhydride and acrylic acid (or methacrylic acid, acrylamide, etc.). The second step is starch grafting.

In the first step, partially neutralized maleic acid/anhydride and unsaturated monomer are placed in a reaction vessel, heated, and stirred. Initially, the pH value of the reaction system should be from about 2 to 12, and this value decreases as copolymerization proceeds. When the temperature of the reaction solution reaches 90 to 150° C., a composition initiator and a slow copolymerization agent are added to the reaction solution over 3 hours. The monoethylenically unsaturated monomer is optionally selected from acrylic acid, methacrylic acid, acrylamide, etc.

In the second step, starch, with more initiator, is added in the reaction vessel over several hours. Then the starch graft copolymerization is completed over 2 hours.

The slow polymerization agent is a bivalent cation such as Fe⁻⁻, Ni⁺⁺, Zn⁺⁺, Cu⁺⁺, Co⁺⁺, Mn⁺⁺, etc. The content of said slow polymerization agent is from 0.1 to 100 ppm relative to total weight of the monomers.

The above starch graft copolymer is especially effective and relatively low in cost, and is highly biodegradable, preferably useful as a detergent additive polymer to serve as a builder, alkaline pH buffer, chelate of calcium and magnesium cations, anti-filming agent, dispersant, anti-redeposition agent, enzyme performance-improving agent, sequestering agent and encrustation inhibitor. It can also improve free-flowing characteristics and solubility of granules, and can be used as a water-treatment chemical.

The starch graft copolymers can be used as described above or, optionally, can be used as a component of a non-phosphate, non-aluminosilicate detergent builder. The non-phosphate, non-aluminosilicate detergent builder composition of the present invention may be in any of the usual physical forms, such as granular, powders, liquids, pastes, and the like. The detergent builder compositions of the present invention can be prepared by drying an aqueous slurry comprising the components, or by agglomeration, or by mixing the ingredients into an aqueous solution or suspension. The effects are obtained regardless of the method of preparation.

Examples of the non-phosphate, non-aluminosilicate detergent builder compositions of the present invention can be selected from the group consisting of mixtures of a polyethylene glycol and the graft copolymer to starch of acrylic acid and maleic acid/anhydride, mixed with citrate, surfactants, carbonates, silicates, sulfates or mixtures thereof.

Amounts by weight of the individual substances used in the preparation of detergent builder compositions based on the total weight of the detergent builder composition are, for example, up to 85% sodium sulfate, up to 45% sodium carbonate, up to 40% silicate, up to 20% starch graft copolymer, up to 10% polyethylene glycol (which has a weight average molecular weight from about 1,000 to about 50,000), up to 8% citrate, and up to 5% nonionic surfactant.

Because of the severe environmental pollution caused by the use of phosphates, the phosphate content of detergent and cleaning agent formulations is currently being reduced so that detergents contain less than about 30% of phosphates and are preferably phosphate-free. In certain liquid detergent markets, the use of builders is usually limited to citric acid and its salts, or a combination of citrate and fatty acid soap. In other markets, liquid detergent compositions incorporate an intermediate level of soap, about 15%, or tripolyphosphate, about 20%, to assist overall cleaning efficacy.

Other common additives to detergent and cleaning agent formulations are bleaching agents, used in an amount of up to 30 wt %, corrosion inhibitors such as silicates, used in an amount of up to 25 wt %, and graying inhibitors used in an amount of up to 5%. Suitable bleaching agents include, for example, perborates, percarbonates and chlorine-generating substances such as chloroisocyanurates. Suitable silicates used as corrosion inhibitors include, for example, sodium silicate, sodium disilicate and sodium metasilicate. Examples of graying inhibitors include carboxymethylcellulose, methylcellulose, hydroxypropylmethylcellulose, and graft copolymers of vinyl acetate and polyalkylene oxides, having a molecular weight of 1,000 to 15,000. Other common detergent additives optionally used are optical brighteners, enzymes and perfumes. Powdered detergent formulations can also contain up to 50 wt % of an inert diluent, such as sodium sulfate, sodium chloride, or sodium borate. The detergent formulations can be anhydrous or they can contain small amounts, for example up to 10 wt %, of water. Liquid detergents can contain up to 80 wt % water as an inert diluent.

The above-described biodegradable starch graft copolymers and the non-phosphate, non-aluminosilicate detergent builder of the present invention can be added to any detergent or cleaning agent formulation. The starch graft copolymers are used in amounts between 0.1 and 30 wt %, preferably between 1 and 16 wt %, based on the total weight of the formulation. In most cases, particularly when used as soil redeposition inhibitors, the amount of biodegradable starch graft copolymer actually used is preferably between 2 and 10 wt % of the detergent or cleaning agent mixture. The non-phosphate, non-aluminosilicate detergent builder is used in amounts from 1 to 80 wt %, preferably between 10 and 50 wt %, based on the total weight of the formulation. Of particular importance is the use of additives according to the present invention in phosphate-free and low-phosphate detergents and cleaning agents, particularly those containing a precipitant builder such as sodium carbonate. The low-phosphate formulations contain up to a maximum of 25 wt % of sodium tripolyphosphate or pyrophosphate. In view of their biodegradability, the starch graft copolymers according to the invention are preferably used at a high concentration in phosphate-free formulations, and serve as builders in place of the phosphates.

If desired, the biodegradable starch graft copolymers according to the present invention can be used in detergent formulations, replacing non-biodegradable copolymers of acrylic acid and maleic acid or acrylic acid homopolymers. The biodegradable starch graft copolymers according to the present invention have all the properties of non-biodegradable copolymers of acrylic acid and maleic acid or of acrylic acid homopolymers, and have further advantages which these others do not have.

Other applications for the starch graft copolymers of the present invention include water treatment. Water treatment applications for these copolymers include dispersing applications, such as in aqueous clay dispersions for paper making, and anti-nucleating agents where minor amounts of the copolymers can serve as threshold inhibitors against crystal formation and scaling in cooling towers or boilers. When used to inhibit crystal formation or scaling, the water-soluble copolymers are often combined with corrosion inhibitors such as inorganic or organic phosphates or phosphonates, or metallic salts such as zinc compounds and the like. The starch graft copolymers of the present invention can be added directly to an aqueous composition, or can be added as a concentrated aqueous composition wherein the starch graft copolymer is present in the composition at a level of from 15% to 50% by weight.

### EXAMPLES

The following specific examples are intended to illustrate specific embodiments of the invention and should not be interpreted as narrowing the broader aspects of the invention, which should be manifest from the specification. Unless otherwise indicated, all percentages are percentages by weight.

### Starch Graft Copolymer Synthesis

### Example 1

72.6 grams of maleic anhydride, 54.3 grams of acrylic acid and 83.5 grams of sodium hydroxide solution (35%) were placed in a one liter 4-neck flask equipped with a mechanical stirrer, temperature indicator, nitrogen inlet, pressure-equalizing dropping funnel and condenser. This reaction solution in this reactor was heated to 100° C. Then 20 grams of composition initiator (a mixture of 17 grams of 30% sodium persulfate aqueous solution and 3 grams of 30% hydrogen peroxide aqueous solution) and 6 grams of slow copolymerization agent (a 0.005% copper sulfate aqueous solution) were gradually added over 30 minutes. The reaction mixture was then kept under 100° C. for pre-copolymerization for a further 10 minutes. Under nitrogen and with stirring, 300 grams of starch solution (36%) and 5 grams of composition initiator were gradually added to the reaction mixture over 60 minutes, Once the additions were complete, the system was reacted for an additional 120 minutes.

The resultant copolymer solution had a solids content of 41.3%. Its polar viscosity was 0.52 dL/g, the bromine value was 0.25, and the calcium-chelation ability was 471 mgCaCO₃ per gram of the copolymer solution.

### Example 2

The procedure of Example 1 was repeated except that the mole ratio of maleic anhydride to acrylic acid was 5 to 3.

The resultant copolymer solution had a solids content of 42.8%. Its polar viscosity was 0.62 dL/g, the bromine value was 0.23, and the calcium-chelation ability was 398 mgCaCO₃/g.

### Example 3

The procedure of Example 1 was repeated except that the mole ratio of maleic anhydride to acrylic acid was 3 to 5.

The resultant copolymer solution had a solids content of 41.9%. Its polar viscosity was 0.14 dL/g, the bromine value was 0.19, and the calcium-chelation ability was 438 mgCaCO₃/g.

### Example 4

The procedure of Example 1 was repeated except that the mole ratio of maleic anhydride to acrylic acid was 1 to 1.

The resultant copolymer solution had a solids content of 41.6%. Its polar viscosity was 0.45 dL/g, the bromine value was 0.20, and the calcium-chelation ability was 419 mgCaCO₃/g.

### Example 5

The procedure of Example 1 was repeated except that the initiator weight based on the total weight of unsaturated monomers was 3.5%, and the weight ratio of persulfate to hydrogen peroxide was 9 to 1.

The resultant copolymer solution had a solids content of 40.6%. Its polar viscosity was 0.23 dL/g, the bromine value was 0.67, and the calcium-chelation ability was 389 mgCaCO₃/g.

### Example 6

The procedure of Example 1 was repeated except that the initiator weight based on the total weight of unsaturated monomers was 5.0%, and the weight ratio of persulfate to hydrogen peroxide was 9 to 1.

The resultant copolymer solution had a solids content of 40.9%. Its polar viscosity was 0.37 dL/g, the bromine value was 0.63, and the calcium-chelation ability was 469 mgCaCO₃/g.

### Example 7

The procedure of Example 1 was repeated except that the initiator weight based on the total weight of unsaturated monomers was 6.5%, and the weight ratio of persulfate to hydrogen peroxide was 9 to 1.

The resultant copolymer solution had a solids content of 40.1%. Its polar viscosity was 0.13 dL/g, the bromine value was 0.57, and the calcium-chelation ability was 371 mgCaCO₃/g.

### Example 8

The procedure of Example 1 was repeated except that the total reaction time was 2 hours.

The resultant copolymer solution had a solids content of 41.3%. Its polar viscosity was 0.89 dL/g, the bromine value was 1.37, and the calcium-chelation ability was 321 mgCaCO₃/g.

### Example 9

The procedure of Example 1 was repeated except that the total reaction time was 3 hours.

The resultant copolymer solution had a solids content of 41.3%. Its polar viscosity was 1.18 dL/g, the bromine value was 0.27, and the calcium-chelation ability was 398 mgCaCO₃/g.

### Example 10

The procedure of Example 1 was repeated except that the total reaction time was 5 hours.

The resultant copolymer solution had a solids content of 41.3%. Its polar viscosity was 1.58 dL/g, the bromine value was 0.26, and the calcium-chelation ability was 436 mgCaCO₃/g.

### Example 11

The procedure of Example 1 was repeated except that the reaction temperature was 90° C.

The resultant copolymer solution had a solids content of 41.3%. Its polar viscosity was 1.08 dL/g, the bromine value was 1.77, and the calcium-chelation ability was 336 mgCaCO₃/g.

### Example 12

The procedure of Example 1 was repeated except that the reaction temperature was 110° C.

The resultant copolymer solution had a solids content of 41.3%. Its polar viscosity was 1.41 dL/g, the bromine value was 0.20, and the calcium-chelation ability was 466 mgCaCO₃/g.

### Example 13

The procedure of Example 1 was repeated except that the reaction temperature was 120° C.

The resultant copolymer solution had a solids content of 41.3%. Its polar viscosity was 1.61 dL/g, the bromine value was 0.31, and the calcium-chelation ability was 458 mgCaCO₃/g.

### Example 14

The procedure of Example 1 was repeated except that the weight ratio of persulfate to hydrogen peroxide was 1 to 1.

The resultant copolymer solution had a solids content of 41.2%. Its polar viscosity was 0.47 dL/g, the bromine value was 0.53, and the calcium-chelation ability was 329 mgCaCO₃/g.

### Example 15

The procedure of Example 1 was repeated except that the weight ratio of persulfate and hydrogen peroxide was 1 to 2.

The resultant copolymer solution had a solids content of 41.2%. Its polar viscosity was 0.34 dL/g, the bromine value was 0.51, and the calcium-chelation ability was 343 mgCaCO₃/g.

### Example 16

The procedure of Example 1 was repeated but the reaction conditions were: the mole ratio of maleic anhydride to acrylic acid was 5 to 3; the initiator weight based on the total weight of unsaturated monomers was 5.0%; the weight ratio of persulfate and hydrogen peroxide was 1 to 2; the weight ratio of starch to the total weight of monomers was 1 to 1; the reaction temperature was 110° C.; and the reaction time was 5 hours.

The resultant copolymer solution had a solids content of 41.3%. Its polar viscosity was 0.50 dL/g, the bromine value was 0.51, and the calcium-chelation ability was 449 mgCaCO₃/g.

### Detergent Builder Composition Preparation

Compositions of non-phosphate, non-aluminosilicate detergent builders included from about 1% to about 20% of a mixture of polyethylene glycol and the graft copolymer to starch of acrylic acid and maleic acid/anhydride. In these mixtures, the polyethylene glycol: starch graft copolymer weight ratio was from about 1:10 to about 10:1. The polyethylene glycol had a weight average molecular weight of from about 1,000 to about 50,000, and the starch graft copolymer had a polar viscosity of from about 0.01 to 10 dL/g.

Proportions by weight in the detergent builder compositions, based on the total weight of the detergent builder composition, were, for example, up to 85% sodium sulfate, up to 45% sodium carbonate, up to 40% silicate, up to 20% starch graft copolymer, up to 10% polyethylene glycol, up to 8% citrate, and up to 5% nonionic surfactant.

The non-phosphate, non-aluminosilicate detergent builders could be prepared directly in the preparation of granular detergent builders, and could also be prepared by spray-drying an aqueous slurry of the components. A resultant detergent builder (FS) had high water solubility and was highly biodegradable. Its calcium-chelation ability was 345 mgCaCO₃/g, and its magnesium chelation ability was 350 mgMgCO₃/g.

### Functional Groups Characterised

The starch graft copolymers of the Examples were characterized by infrared spectrometry (JASCO A-320).

### Structure Inspection

The structures of the starch graft copolymers were viewed using a scanning electron microscope (KYKy 1000-B). Scanning electron micrographs were taken. (see FIGS. 1 to 3).

### Polar Viscosity Testing

Polar viscosity testing was done according to China National Standard GB 10534-89.

### Bromine Value Testing

Bromine value testing was done according to China National Standard GB 10534-89.

### Calcium-chelation Ability

Calcium-chelation ability was tested by the following direct titration method. A sample (copolymer) solution was directly titrated with standard calcium acetate solution. An end point was reached when permanent white precipitate was just forming. Calcium-chelation ability was calculated by the following formula:

Calcium-chelation ability(mgCaCO₃/g sample )=Volume of calcium acetate solution×Content of calcium acetate solution×Molecular weight of CaCO₃

### Magnesium Chelation Ability

The testing of magnesium chelation ability was similar to that of calcium-chelation ability.

### Water Solubility

The resultant detergent builder(FS) had very good water solubility as shown in Table 1.

TABLE 1
Water solubility of FS at different temperatures

| T(° C.) | 0 | 10 | 20 | 30 | 40 |
|---|---|---|---|---|---|
| FS g/100 g | 50 | 53 | 56 | 58 | 60 |
| Water | | | | | |

What is claimed is:

1. A water-soluble graft copolymer comprising:
a substantially completely biodegradable substrate including a natural polymer; and
a copolymer grafted to the substrate, the copolymer including
at least one monoethylenically unsaturated monocarboxylic acid, and
at least one co-monomer that includes at least two unsaturated non-conjugate double bonds and at least one COO—X group.

2. The graft copolymer of claim 1, wherein the graft copolymer comprises a polar viscosity of from 0.01 to 10 dL/g.

3. The graft copolymer of claim 1, further comprising at least one water-soluble metal salt.

4. The graft copolymer of claim 1, wherein the copolymer grafted to the substrate comprises an acid-functional monomer.

5. The graft copolymer of claim 1, wherein the copolymer grafted to the substrate comprises at least one of maleic acid and anhydride.

6. The graft copolymer of claim 1, wherein the copolymer grafted to the substrate comprises at least one of acrylic acid, methacrylic and acrylamide.

7. The graft copolymer of claim 1, wherein the substrate comprises starch.

8. The graft copolymer of claim 1, wherein the graft copolymer comprises a weight ratio of the substrate to the copolymer of from 1:9 to 9:1.

9. The graft copolymer of claim 1, wherein the graft copolymer comprises a calcium ion chelation ability of at least 300 mgCaCO₃/g.

10. The graft copolymer of claim 1, wherein the graft copolymer comprises a mole ratio of the at least one monoethylenically unsaturated monocarboxylic acid to the at least one co-monomer of from 1:9 to 9:1.

11. A detergent builder composition comprising a water-soluble graft copolymer including:
a substantially completely biodegradable substrate; and
a copolymer grafted to the substrate, the copolymer including
at least one monoethylenically unsaturated monocarboxylic acid, and
at least one co-monomer that includes at least two unsaturated non-conjugate double bonds and at least one COO—X group.

12. The composition of claim 11, wherein the composition is substantially water-soluble, and substantially free of phosphate and aluminosilicate.

13. The composition of claim 11, further comprising: polyethylene
glycol mixed with the graft copolymer; and
at least one selected from the group consisting of citrate, surfactants, carbonates, silicates and sulfates.

14. The composition of claim 11, further comprising an alkali metal silicate in an amount of from 1 to 30% by weight, the alkali metal silicate including a molar ratio of from 1.6 to 2.4.

15. The composition of claim 11, further comprising polyethylene glycol mixed with the graft copolymer, a mixture content of the polyethylene glycol and the graft copolymer in the composition being from 1 to 20%, the mixture including a polyethylene glycol: graft copolymer weight ratio of from 1:10 to 10:1, the polyethylene glycol including a weight average molecular weight of from 1,000 to 50,000, and the graft copolymer including a polar viscosity of from 0.01 to 10 dL/g.

16. The composition of claim 11, wherein the detergent builder composition is granular.

17. A method for producing a water-soluble graft copolymer, the method comprising the steps of:
(a) copolymerizing a plurality of monoethylenically unsaturated monomers including at least one of maleic acid and anhydride; and
(b) adding starch for grafting to the starch a copolymer formed in the step of copolymerizing.

18. The method of claim 17, further comprising the step of adding a composition initiator which includes persulfate and hydrogen peroxide with a persulfate: hydrogen peroxide weight ratio of from 40:1 to 1:1, the initiator including a weight amount of from 0.1 to 20% relative to total weight of the monoethylenically unsaturated monomers.

19. The method of claim 17, wherein pH of a reaction system at commencement of the step of copolymerizing is from 12 to 2, and the pH decreases during the step of copolymerizing.

20. The method of claim 17, wherein the step of copolymerizing includes adding a slow polymerization agent including a bivalent cation in a weight amount of from 0.1 to 100 ppm relative to total weight of the monoethylenically unsaturated monomers.
